(19) United States
(12) Patent Application Publication
(10) Pub. No.: US 2025/0146335 A1
(43) Pub. Date: May 8, 2025

(54) Vehicle Door for a Motor Vehicle and Method for Operating Such a Vehicle Door

(71) Applicant: Bayerische Motoren Werke Aktiengesellschaft, Muenchen (DE)

(72) Inventors: Klaus BRUECKLMEIER, Muenchen (DE); Markus KOEDDERITZSCH, Woerthsee (DE); Olaf KOEHLER, Karlsfeld (DE); Reinhard PEIS, Zolling (DE); Manuel WERNICKE, Dachau (DE)

(21) Appl. No.: 18/838,117

(22) PCT Filed: Jan. 23, 2023
(86) PCT No.: PCT/EP2023/051543

§ 371 Date: Aug. 13, 2024

(30) Foreign Application Priority Data
Feb. 21, 2022 (DE) 10 2022 104 046.1

(51) Int. Cl. E05B 81/76; E05B 81/20; E05B 85/10

(52) U.S. Cl. CPC E05B 81/77; E05B 81/20; E05B 85/107

(57) ABSTRACT

A vehicle door for a motor vehicle includes an electronic operating element on an outside of the vehicle door via which an electric door lock can be opened and includes a handle element for opening the vehicle door. In order to create a vehicle door, in which the electronic operating element is particularly well protected, the electronic operating element can be moved between a stowed position and an operating position.

### BACKGROUND AND SUMMARY

The invention relates to a vehicle door for a motor vehicle, having an electronic operating element on the outside of the door. The invention also relates to a method for operating a vehicle door of this kind.

A vehicle door of this kind is already known, for example, from the Ford Mustang Mach-E (year of manufacture 2021). It is provided with an electronic operating element of a door pillar panel of the vehicle door on the outside of the door, it being possible for an electric door lock to be unlocked or opened by way of the electronic operating element, as a result of which the vehicle door is opened a short way out of its closed position on account of the sealing forces. A handle element, by way of which the vehicle door can be manually opened, is accessible as a result. Here, the handle element extends in a manner overlapped by a trim strip level with a sill line of the vehicle door and is accordingly free or graspable only when the vehicle door is moved out of its closed position.

The object of the present invention is to provide a vehicle door and a method for operating it, in which the operating element is particularly expediently protected.

The vehicle door according to the invention comprises an electronic operating element, by way of which an electric door lock can be opened, on the outside, and a handle element for opening the vehicle door. According to the invention, provision is made here for the operating element to be able to be moved between a stowed position and an operating position. This allows the operating element to be accommodated in a particularly protected manner in the stowed position and therefore to be protected, for example, against weathering influences or damage, for example due to vandalism. Here, the operating element can be moved, in particular when the vehicle is stationary, from the stowed position into the operating position, and back. Particularly when the motor vehicle is traveling, the operating element can be arranged in the stowed position in order to prevent, for example, damage or wear during travel or to improve the aerodynamics of the vehicle.

In an expedient embodiment, the operating element can be integrated into a handle element for opening the vehicle door, which handle element, for its part, can be moved between the stowed position and the operating position. Overall, this results in expedient movement both of the handle element and the operating element.

In a further advantageous refinement of the invention, the operating element is arranged in a region of the handle element that is hidden from an outer side and/or a top side and is therefore also particularly expediently positioned in the operating position. Since the operating element is integrated into the handle element, it is therefore possible, with merely a manual operating action or without the operating element being grasped by the operator's hand, both to unlock or to open the electric door and also to then open the vehicle door manually.

In addition, it is advantageous when the operating element has at least one touch sensor device by means of which a door opening signal for electrically opening the door lock can be generated. Owing to the touch sensor device, an electrical signal or the like is generated here, by means of which electrical signal the electric door lock or an associated actuator or the like is actuated in order to unlock the door lock.

A further advantageous refinement of the invention makes provision for the operating element to have at least one sensor device for automatically opening the vehicle door by means of a door drive in an automatic mode and one sensor device for manually opening the vehicle door by means of the handle element and assisted by a door drive in a servo mode. Accordingly, the user or vehicle occupant can selectively automatically open or close the door by means of a door drive, or else open or close the vehicle door using the handle element manually and with assistance by the door drive in the servo mode. For this purpose, only contact or similar operation of the corresponding sensor device is required. In other words, it is possible for an operator, for example the driver or another vehicle occupant, to open and/or to close the door automatically, specifically in the automatic mode, or manually, with force assistance, in the servo mode. Here, it is additionally conceivable for the operator to switch the vehicle door between the automatic mode and the servo mode during the respective opening or closing process or between the opening process and the closing process.

It is also advantageous when the operating element is arranged at least partially in a window shaft of the vehicle door in the stowed position and is arranged in the region of a sill line of the vehicle door in the operating position. In this way, the operating element can be arranged firstly in a particularly expedient position in the operating position and secondly accommodated particularly securely in the stowed position. In addition, the handle element can be arranged discreetly in a particularly expedient manner, so that this firstly has hardly any effect on the aerodynamics of the vehicle in the region of the vehicle door and secondly a vehicle door without a door handle can be implemented as desired since only a, for example, extremely small handle element is required in the region of the sill line and/or the door pillar panel. However, a door handle in the region below the sill line of the vehicle is not required. In this respect, the vehicle door is a handleless door.

In a further refinement of the invention, the operating element can be activated by a near-field communication device and can be moved between the stowed position and the operating position. A near-field communication device of this kind can be arranged, for example, within the operating element and interact, for example, with a remote control arrangement which can be actuated by the operator or which interacts with the near-field communication device on the vehicle by the operator approaching the vehicle.

An embodiment in which the operating element has at least one indicator for at least an operating state, an electrical charge state or the like has proven particularly advantageous. Indicators of this kind can be designed, for example, as LED strips or the like. In particular, in addition to a charge state of respective components of the vehicle door, it is also possible to indicate in this way whether the vehicle door is locked or unlocked.

It has also proven advantageous when a control device, which is designed to control the electronic operating element and the electric door lock, is integrated into the vehicle door. Owing to a control device of this kind provided inside the door and having a corresponding electronic architecture, the desired functions can be implemented in a particularly expedient manner.

The invention also comprises a method for operating a vehicle door of this kind, the advantages of which can be derived from the above-described advantages of the vehicle door.

Further features of the invention can be found in the claims, the figures and the description of the figures. The features and combinations of features that are cited in the description above and the features and combinations of features that are cited in the description of the figures below and/or that are shown in the figures alone can be used not only in the respectively indicated combination but also in other combinations or on their own.

The invention will now be explained in more detail on the basis of a preferred exemplary embodiment and with reference to the drawings.

### BRIEF DESCRIPTION OF THE DRAWINGS

FIG. 1 shows a side view of a detail of a passenger car having a front and a rear vehicle door on each side of the vehicle, the vehicle doors being equipped with symbolically indicated components for electrically or for electronically controlling the vehicle door; and

FIG. 2 shows schematic sectional views through the vehicle door in the region of an operating element of the vehicle door, the operating element being arranged at least partially in a window shaft of the vehicle door between in a stowed position illustrated on the left-hand side and being able to be moved from the stowed position into an operating position illustrated on the right-hand side in the region of a sill line of the vehicle door.

### DETAILED DESCRIPTION OF THE DRAWINGS

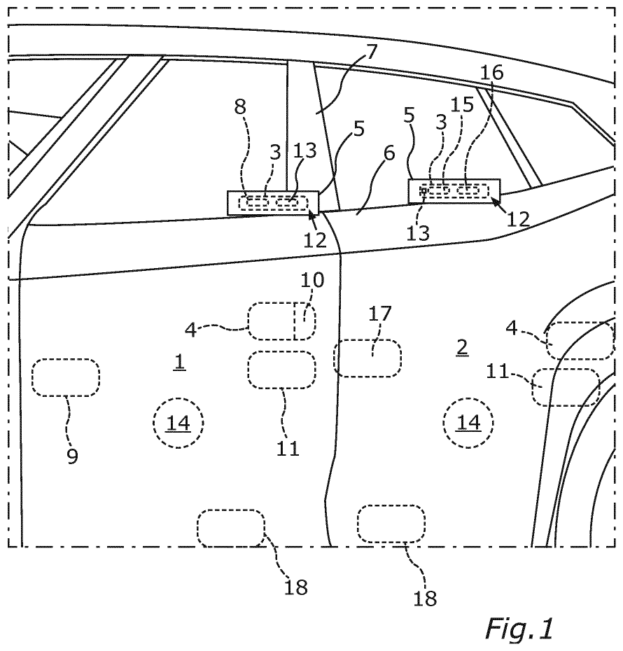

FIG. 1 shows a front and a rear vehicle door 1, 2 of a passenger car. Although the present invention is explained in connection with these vehicle doors 1, 2, it is likewise conceivable for the vehicle door to be designed in a different way to the pivot doors which are each attached at the front in the present case, for example as a rear hatch, rear door or similarly movable or configured vehicle door.

In the present case, the front vehicle door 1 is configured as a basic version, and the rear vehicle door 2 is configured with corresponding special equipment.

The front vehicle door 1 comprises a symbolically indicated electronic operating element 3 on the outside of the door, by means of which an operator or vehicle occupant, in particular the driver here, can gain access to the vehicle interior. A likewise merely symbolically indicated electric door lock 4 of the front vehicle door 1 can be actuated and accordingly can be unlocked or can be opened by way of this operating element 3. Accordingly, the present electric door lock 4 is equipped, for example, with an electric actuator or similar actuating element or drive, so that the electric door lock 4 can be unlocked or possibly also locked as a result of a corresponding signal initiated by the operating element 3.

In the present case, the operating element 3 is integrated into a likewise merely highly schematically indicated handle element 5 which is arranged in the region of a sill line 6 in the present case. As an alternative to this, the handle element 5 can also be arranged in another location, in particular in the region of a rear door pillar panel 7 of the front vehicle door 1.

The handle element 5 can be designed, in particular, as an extremely small wing or the like in the region of the sill line 6 and protrude, for example, obliquely upward, the wing being designed to be much smaller than illustrated in the single figure. The size in the single figure is therefore not true to scale, but rather much larger than the actual handle element 5 merely for reasons of clarity.

The operating element 3 can be protected, for example, on an inner side of the handle element 5 which faces away from the outer side and thus is arranged in a manner largely hidden from the outside. However, the operating panel 3 is arranged such that it is accordingly visible to the operator as they approach the vehicle. However, the operating panel 3 can be arranged such that it is visible and accessible from the outside.

In the present case, the operating element 3 comprises at least one touch sensor device 8, which is also referred to as a touch sensor system. This touch sensor device 8 can react, for example as an inductive sensor device, to direct finger contact or else, for example also as a capacitive sensor device, to being corresponding approached by means of a finger or the like. Other solutions for the present touch sensor device 8 are also conceivable, for example by a piezoelectric or PTC button, or a button which is covered by a metal cover (metal over cap).

If manual contact is accordingly made with the corresponding touch sensor device 8 with the operating element 3 activated, a door opening signal for electrically unlocking or opening the door lock 4 is generated as a result and in this way the vehicle door is opened from the closed position illustrated here only to the outside as a result of the sealing forces acting in the direction of the outside of the vehicle. Since the operating element 3 and the touch sensor device 8 are integrated into the handle element 5, the operator accordingly does not need to grasp the handle element in order to further manually open the vehicle door 1, but rather the corresponding pivoting movement of the vehicle door 1, designed as a pivot door here, can be implemented by means of the handle element 5. In other words, it is therefore possible for the operator of the front vehicle door 1 to trigger the opening process of the door lock 4 with just a single hand action initially by touching the touch sensor device 1 and without further grasping then moving the handle element 5, in which the operating element 3 with the touch sensor device 9 is illustrated, further into the open position. Particularly simple, quick and convenient opening of the vehicle door 1 is possible in this way.

The vehicle door 1 further comprises a schematically indicated electrical door braking device 9 which in the present case is arranged in the front region of the vehicle door 1 close to the pivot axis of the vehicle door. In contrast to a catch strap or a mechanical door brake, the advantage of an electrical door braking device 9 of this kind is that door movement forces can be reduced to possible potential energy, which results owing to an inclined position of the vehicle and the resulting forces, and to forces which result from hinge friction. In other words, it is accordingly possible to reduce the door opening movement in order to reduce those forces that act on the vehicle door 1 for example due to a sloping position of the vehicle or forces which are introduced for example by hinge friction. In addition, an electrical door braking device 9 of this kind also allows the vehicle door to be held at different opening pivot angles or in different opening states. In particular, the opening position or the opening pivot angle can also be adjusted here, depending on the side from which a vehicle seat occupant approaches the vehicle.

A door pull-close device 10, which is associated with the electric door lock 4 schematically arranged at the rear end of the vehicle door 1 in the present case, is also integrated into the vehicle door 1. Such a door pull-close device 10, which is usually referred to as a soft- close device, allows the vehicle door to be correspondingly caught by means of a corresponding catch device and a drive, for example an electric drive, during closing, in particular during manual closing by means of the handle element 5, and after a position just before the closed position is reached and to be moved against the sealing forces of the door seal of the vehicle door 1 to the closed position. Particularly when the vehicle door 1 is manually closed, a considerable application of manual force for reaching the closed position can be avoided by way of the vehicle door 1 having to be moved only as far as close to the closed position, after which the door pull-close device 10 performs the final closing process into the closed position. As an alternative to integration of the door pull-close device 10 into the electric door lock 4, a separate design of this structural unit would also be conceivable in the present case.

A schematically indicated opening device 11 for opening the vehicle door 1 from its closed position over a short distance against high forces, for example of up to 1000 N, is also provided at the rear end of the vehicle door 1 below the door lock 4. Accordingly, in particular forces occurring in the event of emergency opening in the case of freezing or a crash for overcoming the closed position of the vehicle door 1 can be generated by means of this opening device 11. Here, corresponding forces, which are caused for example by ice formation on the vehicle door 1 or by a collision, in particular a side collision against the motor vehicle in the region of the vehicle door 1, are accordingly overcome here. For this purpose, the opening device 11 has, for example, a corresponding drive, so that corresponding forces can be applied between the vehicle door 1 and the shell of the motor vehicle by means of a tappet or the like in order to open the vehicle door 1 from its closed position. Here, interaction between the opening device 11 and the electric door lock 4 and the door pull-close device 10 is required for the purpose of the electric door lock 4 or the door pull-close device 10 to accordingly have to be separated from the vehicle door 1 or opened.

The electrical opening device 11 can be designed as part of the electric door lock 4 here and represented for example by the opposite movement direction of the door pull-close device 10, that is to say to the outside in the direction of travel. A separate design of the opening device 11 is also conceivable.

A near-field communication device (NFC) 12, which is provided or designed to communicate for example with a remote control element of the operator, in particular the driver, is preferably also integrated into the operating element 3. As a result, the operating element 3 can be accordingly activated and switched on by a corresponding, possibly manual signal or by the operator approaching the vehicle (comfort access), so that it is switched on for implementing the further functions. Conversely, the operating panel 3 can also be deactivated, for example by manual operation of a remote control arrangement or by the operator moving away from the vehicle, by means of the wireless data exchange between the near-field communication device 12 and the remote control arrangement or the like. It is of course also conceivable to not arrange the near-field communication device 12 in the region of the operating element 3, but rather in another location in the vehicle.

Furthermore, at least one indicator for at least an operating state, an electrical charge state or the like is integrated into the operating element 3. Accordingly, an opening or closing state of the vehicle door 1, correct functioning or the like can be indicated to an operator of the vehicle door 1 by means of this at least one indicator 13. The charge state for example of the electrical units of the vehicle door 1 or the entire vehicle can also be indicated. Further electronic indicators, sensors or the like can also be integrated into the operating element 3.

Finally, a control device 14 integrated into the vehicle door 1 can be seen in the region of the vehicle door, this control device being designed to correspondingly control the electronic operating element 3, the electric door lock 4, the electrical door braking device 9, the electrical door pull-close device 10 and the electrical opening device 11.

For this purpose, a corresponding electronic architecture of the individual components is required within the vehicle door 1. Accordingly, the control device 14 is designed to activate the operating element 3 given corresponding signaling by means of a remote operating element and corresponding wireless data transmission via the near-field communication device 12 and furthermore to implement electrical opening of the door lock 4 when contact is made with the touch sensor device 8 of the operating element 3. Furthermore, the control device 14 is designed to control the manual door opening movement by means of the door braking device 9 with respect to the door movement forces and the opening pivot angle. In addition, the control device 14 is designed to activate or to control the door pull-close device 10 when the door is manually closed, until the vehicle door 1 has reached its closed position again. The control device 14 is likewise designed to correspondingly control the opening device 11 in the case of freezing or in the event of a crash. Finally, the control device 14 is also designed to deactivate the operating element 3 given a corresponding signal or if the operator moves away or in the case of remote control. Here, the control device 14 can make use of signals from further sensors, cameras or the like which are integrated for example discreetly into the vehicle door 1 or are arranged in another location in the vehicle or else also outside the vehicle.

Analogously to the front vehicle door 1, the rear vehicle door 2 also has an electronic operating element 3 on the outside of the door, it being possible for an electric door lock 4 to be opened by way of the electronic operating element, wherein the operating element is integrated into the handle element 5. In terms of the specific configuration of the handle element 5 with the operating element 3, reference is made to the embodiments relating to the configuration of the front vehicle door 1 in this respect.

In contrast to the embodiment for the front vehicle door 1, the operating element 3 in the present case has at least one sensor device 15 for automatically opening the vehicle door 2 by means of a merely schematically indicated door drive 17 in an automatic mode and a sensor device 16 for manually opening the vehicle door 2 by means of the handle element 5 and assisted by a door drive 17 in a servo mode.

In the present case, the rear vehicle door 2 accordingly can be opened by actuating the sensor device 15 in an automatic mode or else by actuating the sensor device 16 in an assisting servo mode. For this purpose, a common door drive 17 can be used for the automatic mode and the servo mode. However, as an alternative to this, it would also be conceivable to use respectively separate door drives for implementing the automatic mode and the servo mode.

In the present case, the door drive 17 is arranged close to the door pivot axis schematically in the front region of the rear vehicle door 2. Here, the door drive 17 has a corresponding electric motor, actuator or similar actuating means by means of which an automatic mode or a servo mode is activated as a result of the respective actuation of the sensor device 15 or 16. In so doing, the door drive 17 also performs the function of a door braking device, that is to say limits, for example, respective opening positions or opening pivot angles of the vehicle door 2. The door drive may also perform the function of the door pull-close device 10, as is described in connection with the front vehicle door 1. However—analogously to the embodiment according to FIG. 1—a separate door pull-close device 10 can also be provided, as is the case here. In this respect, reference is made in terms of the function of the door pull-close device 10 to the statements made in connection with the front vehicle door 1.

If the sensor device 15 or the sensor device 16, which can both be designed as touch sensor devices, is actuated, as has already been described in connection with the exemplary embodiment with reference to the front vehicle door 1, can be designed, signaling for opening or unlocking the electric door lock 4 is initially performed, so that the vehicle door 2 is opened as a result of the sealing forces acting owing to the door seal or in the further course is automatically opened in the automatic mode by means of the door drive 17 or can be correspondingly opened when the sensor device 16 is actuated, as has already been described in connection with the front vehicle door 1. It is again advantageous here that no manual grasping between the operation of the sensor device 16 and the opening of the vehicle door 2 by actuating the handle element 5 is required.

While, during opening in the automatic mode, the door drive 17 automatically performs the entire opening process for the vehicle door 2, the door drive 17 acts in the manner of the door braking device of the front vehicle door 1 in respect of limiting the door opening or corresponding door stops. In addition, corresponding force assistance can be performed by the door drive 17, so that even a slight tap is enough to move the vehicle door 2. Accordingly, both potential energy acting on the vehicle door 2 and also hinge friction forces can be absorbed by way of the door drive 17 in the servo mode.

Therefore, overall, it is clear that in the present case an operating element 3 which is integrated into the handle element 5 is provided, in the case of which firstly automatic actuation of the vehicle door 2 and secondly servo-assisted actuation of the vehicle door 2 are possible both during opening and during closing. Here, the respective mode can also be different or changed when the door is opened or closed. It is merely necessary to touch the corresponding sensor device 15, 16 for this purpose.

Analogously to the front vehicle door 1, a corresponding opening device 11 for overcoming forces for example as a result of a film of ice forming or an accident is also provided in the rear vehicle door 2. In this respect, reference is also made to the statements made in connection with the front vehicle door 1. Corresponding indicators 13 in respect of the opening or closing state of the vehicle door 2, the charge state or else also in respect of the automatic or servo mode can be provided in the present operating element 3 of the rear vehicle door 2. In this respect, reference is made to the statements made in this respect in connection with the front vehicle door 1.

In addition, reference is also made in terms of the near-field communication device 12 to the statements made in connection with the front vehicle door 1.

In particular, a plurality of sensors 18 for monitoring the environment, identifying obstacles or the like are also provided in the rear vehicle door 2. These sensors are required in particular for generating signals on the basis of which the door drive 17 can be controlled both in the automatic mode and in the servo mode. Sensors 18 of this kind are also provided in the front vehicle door 1 for controlling the door braking device 9 or other components.

In the present case, the individual electrical or electronic components of the rear vehicle door 2 are also controlled by means of a control device 14 which is designed to control the electronic operating element 3, the electric door lock 4, the door drive 17 and the electrical opening device 11. For this purpose, a corresponding electronic architecture of the individual components within the vehicle door 1 is required.

The control device 14 is accordingly also designed here to generate a corresponding signal for actuation of a remote control element or proximity of the remote control element to the vehicle by means of the near-field communication device 12 in order to activate the operating element 3. The control device 14 is further designed to initially activate the electric door lock 4 and to generate a corresponding unlocking or opening process depending on actuation of the sensor device 15 or 16 when the vehicle door 2 is opened, and furthermore to control the door drive 17 in the automatic mode or in the servo mode depending on actuation of the sensor device 15 or 16. In addition, the control device 14 is designed to activate the opening device 11 in the case of freezing or in the event of a crash.

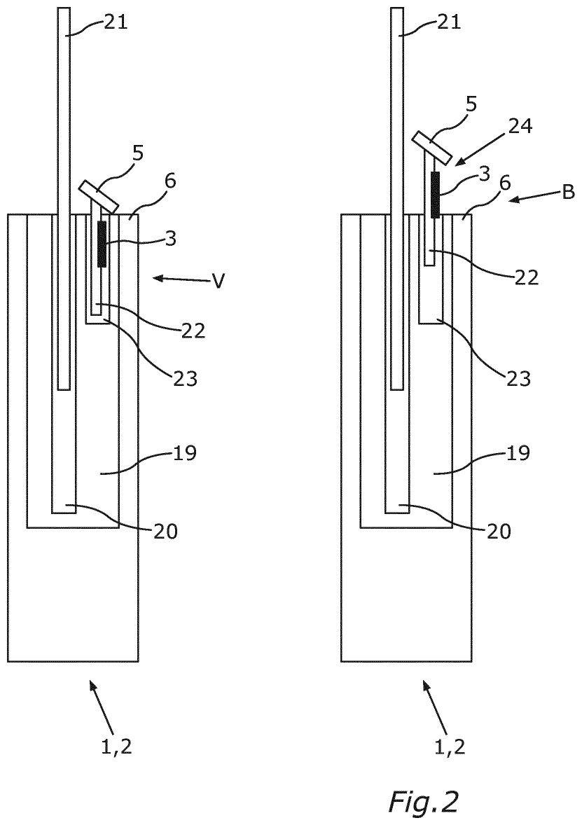

FIG. 2 shows schematic sectional views through the vehicle door 1, 2 in the region of the operating element 3, wherein the refinements described below for the two embodiments of the vehicle door, that is to say both the front vehicle door 1 and also the rear vehicle door 2, can be used.

Here, FIG. 2 schematically shows a window shaft 19 in which a windowpane 21 which can be moved between a closed position and an open position along window guide rails 20 is received.

In the present case, the operating element 3, which is otherwise designed according to the configuration described in connection with the front vehicle door 1 or the rear vehicle door 2, is arranged on a base 22 of the handle element 5 which has already been described in connection with the front and the rear vehicle door 1, 2. Together with this base 22 or the handle element 5, the operating element 3 is arranged between a stowed position V, which is illustrated on the left-hand side and in which the operating element 3 is at least partially, but here entirely, arranged in the window shaft 19 of the vehicle door 1, 2, and an operating position B, which is illustrated on the right-hand side and in which the operating element 3 is located in the region of the sill line 6 of the vehicle door 1, 2 outside the window shaft 19.

In the present case, the base 22 with the operating element 3 is received in a shaft 23, which for its part is arranged in the window shaft 19 of the vehicle door 1, 2, in the stowed position V. Respective rails or other movement elements are arranged in this shaft 23, the base 22 with the operating element 3 and the handle element being able to be moved into the operating position B by means of or along the rails or other movement elements.

In the operating position B, the operating panel 3 and the handle element 5 can be operated or actuated in the manner already described in connection with the front and the rear vehicle door 1, 2.

As can be seen in particular in the illustration on the left-hand side of FIG. 2, the operating element 3 is arranged in a region 24 of the handle element 5 that is hidden from a top side. As a result, the operating element 3 is, for example, well protected against solar irradiation and weathering influences. In particular, the operating element can also be arranged in a manner hidden from the outside in order to be protected, for example, against misuse or vandalism.

Since the handle element 5 can also be moved between the operating position B and the stowed position V together with the operating panel 3, the operating element 3 and consequently the handle element 5 can be arranged in the stowed position V in particular when the motor vehicle is traveling in order to prevent, for example, damage or wear during travel or to improve the aerodynamics of the vehicle.

The operating element 3 can be activated, for example, by the near-field communication device 12 and can be moved between the stowed position V and the operating position B. Owing to a corresponding, possibly manual signal or by the operator approaching the vehicle (comfort access), the operating element 3 can be accordingly activated and extended as a result, so that it is accessible and switched on for implementing the further functions. Conversely, the operating panel 3 can also be deactivated and retracted into the stowed position V by means of the wireless data exchange between the near-field communication device 12 and a remote control arrangement or the like, for example by manual operation of the remote control arrangement or by the remote control arrangement being moved away from the vehicle.

### LIST OF REFERENCE CHARACTERS

1 Vehicle door
2 Vehicle door
3 Operating element
4 Door lock
5 Handle element
6 Sill line
7 Door pillar panel
8 Touch sensor device
9 Door braking device
10 Door pull-close device
11 Opening device
12 Near-field communication device
13 Indicator
14 Control device
15 Sensor device
16 Sensor device
17 Door drive
18 Sensors
19 Window shaft
20 Window guide rails
21 Windowpane
22 Base
23 Shaft
24 Region

1-10. (canceled)

11. A vehicle door for a motor vehicle, comprising:
an electronic operating element disposed on an outside of the vehicle door, wherein an electric door lock is openable via the electronic operating element;
wherein the electronic operating element is movable between a stowed position and an operating position.

12. The vehicle door according to claim 11, wherein the electronic operating element is integrated into a handle element for opening the vehicle door, wherein the handle element is movable between the stowed position and the operating position.

13. The vehicle door according to claim 12, wherein the electronic operating element is disposed in a region of the handle element that is hidden from an outer side and/or a top side of the vehicle door.

14. The vehicle door according to claim 11, wherein the electronic operating element has a touch sensor device via which a door opening signal for electrically opening the electric door lock is generatable.

15. The vehicle door according to claim 12, wherein the electronic operating element has a first sensor device for automatically opening the vehicle door by a door drive in an automatic mode and a second sensor device for manually opening the vehicle door by the handle element and assisted by the door drive in a servo mode.

16. The vehicle door according to claim 11, wherein the electronic operating element is disposed at least partially in a window shaft of the vehicle door in the stowed position and is disposed in a region of a sill line of the vehicle door in the operating position.

17. The vehicle door according to claim 11, wherein the electronic operating element is activatable by a near-field communication device and is movable between the stowed position and the operating position by the near-field communication device.

18. The vehicle door according to claim 11, wherein the electronic operating element has at least one indicator for at least an operating state or an electrical charge state.

19. The vehicle door according to claim 11, further comprising a control device which is configured to control the electronic operating element and the electric door lock, wherein the control device is integrated into the vehicle door.

20. A method for operating a vehicle door for a motor vehicle, comprising the steps of:
moving an electronic operating element from a stowed position into an operating position, wherein the electronic operating element is disposed on an outside of the vehicle door; and
opening an electric door lock by the electronic operating element.
